(19) United States
(12) Patent Application Publication
(10) Pub. No.: US 2025/0217437 A1
(43) Pub. Date: Jul. 3, 2025

(54) IMPLICITLY DEALIASED FFT CONVOLUTIONS FOR REAL DATA

(71) Applicant: ATI TECHNOLOGIES ULC, Markham (CA)

(72) Inventor: Malcolm Roberts, Calgary (CA)

(21) Appl. No.: 18/398,408

(22) Filed: Dec. 28, 2023

(51) Int. Cl. G06F 17/14

(52) U.S. Cl. CPC G06F 17/142

(57) ABSTRACT

Techniques, systems and methods are provided for performing convolution operations on real-valued input data using implicit zero-padding for dealiasing. A set of real-valued input data intended for convolution is embedded into a complex array, reorganizing the real-valued input into a format amenable to fast Fourier transform (FFT) processing. FFT operations are performed on the complex array to generate intermediate frequency-domain results. Pointwise operations on these intermediate results are then performed to integrate the intermediate results in a format that unifies the earlier-separated real-valued input data. The convolution output results matrix is extracted via inverse FFT operations performed on the results of these pointwise operations.

### BACKGROUND

The present invention relates generally to the field of numerical computation, and specifically to techniques for efficiently computing convolutions and correlations on real data using implicit dealiasing.

Convolutions and correlations play an integral role in machine learning, high-performance computing, and a multitude of additional applications such as image processing and signal processing. Leveraging the convolution theorem, which generally states that the Fourier transform of the convolution of two signals is the pointwise product of their Fourier transforms, convolutions and correlations are enabled to be performed as pointwise operations, offering both computational savings and improved accuracy. However, such transforms may lead to aliasing, in which high-frequency components of signal data incorrectly appear as low-frequency components due to undersampling.

### BRIEF SUMMARY OF SELECTED EMBODIMENTS

In an embodiment, a method comprises receiving real-valued input data for convolution; embedding the real-valued input data into a complex array; generating intermediate results by performing one or more fast Fourier transform (FFT) operations on the complex array; performing one or more pointwise operations on one or more portions of the intermediate results; and extracting convolution results for the real-valued input data via one or more inverse FFT operations on at least some results of the one or more pointwise operations.

Embedding the real-valued input data into the complex array may comprise mapping a first subset of the real-valued input data to real parts of the complex array and mapping a second subset of the real-valued input data to imaginary parts of the complex array. Embedding the real-valued input data into the complex array may further comprise storing the first subset of the real-valued input data in a first buffer and storing the second subset of the real-valued input data in a second buffer. The first subset may comprise even-indexed terms of the real-valued input data and the second subset may comprise odd-indexed terms of the real-valued input data. The first subset may comprise a first set of real-valued data to be convolved with a second set of real-valued data, such that the second subset comprises the second set of real-valued input data.

In an embodiment, the real-valued input data comprises a dimensionality of two or more dimensions, such that the one or more FFT operations are performed with respect to the dimensionality of the set of real-valued input data.

In an embodiment, the real-valued input data comprises a first set of real-valued data and a second set of real-valued data, such that embedding the real-valued input data into the complex array comprises combining elements from the first set and from the second set into single complex elements.

In an embodiment, a system comprises a plurality of buffers and one or more processors communicatively coupled to the plurality of buffers, the one or more processors to perform the method.

In an embodiment, a non-transitory computer-readable medium stores a set of executable instructions, the set of executable instructions to manipulate at least one processor to perform the method.

### BRIEF DESCRIPTION OF THE DRAWINGS

FIG. 1 illustrates a one-dimensional (1D) convolution operation in which two N-length input vectors are convolved using explicit zero-padding.

FIG. 2 illustrates a 2D matrix convolution operation in which two N×N input matrices are convolved using explicit zero-padding.

FIGS. 3-1 and 3-2 (collectively referred to herein as FIG. 3) illustrate a 1D convolution operation in which two N-length input vectors are convolved in accordance with some embodiments.

FIGS. 4-1 to 4-9 (collectively referred to herein as FIG. 4) illustrate a 2D matrix convolution operation in which two N×N input matrices are convolved in accordance with some embodiments.

FIG. 5 is a block diagram of a processing system designed to perform convolution operations in accordance with one or more embodiments.

FIG. 6 is an operational flow diagram illustrating a method for performing convolution operations in accordance with one or more embodiments.

### DETAILED DESCRIPTION

Convolution operations play a pivotal role in signal filtering and signal processing. However, performing a linear convolution using a Fast Fourier Transform (FFT) on a limited data set results in cyclic or circular convolution, causing aliasing errors. To circumvent the limitation of circular convolution and to obtain a linear convolution, a practice known as dealiasing is employed.

Dealiasing is typically accomplished by extending the input signals with zeros, a technique commonly referred to as zero-padding. As used herein, padding involves adding a predefined value or set of values added to data to align it to a specific size or structure, such as to ensure that the data conforms to a desired format, to increase the security of encrypted data, or to enhance the performance of certain operations. The actual value(s) and methodology of generating such padding can vary depending on the specific application and requirements. Mathematically, such zero-padding of a matrix F may be represented as:

$$\tilde{F} \dot{=} \{ {F}_{0} , {F}_{1} , … , {F}_{m - 2} , {F}_{m - 1} , {\underbrace{0 , … , 0}}_{m} \} \qquad Equation ( 1 )$$

Zero-padding of input data ensures that circular convolution of the zero-padded signals equates to the linear convolution of the original, unpadded signals. This zero-padding technique effectively eliminates the overlap and aliasing that can inadvertently occur when using FFT for convolution without this precaution. In the context of one-dimensional signals, zero-padding is straightforward, such that the input signals are merely augmented with zeros at the end, effectively doubling its size in that one dimension. For example, a 1D data array of length N would be explicitly extended with an additional N zeros, resulting in a new length of 2N. However, as the dimensionality of the data escalates, the zero-padding process becomes more intricate. In multidimensional scenarios, each dimension of the input data must be extended with zeros, effectively doubling the size of the input in every dimension. This padding ensures that the additional dimensions do not contribute unwanted aliasing artifacts to the final result, but comes with the drawback of a considerable increase in memory requirements due to the augmentation of the dataset.

Zero-padding increases the computational and storage costs of computing the results of FFT-based convolutions. Moreover, explicit zero-padding often involves copying the input to a separate extended-length buffer before such computation can begin, entailing additional memory access operations that would advantageously be avoided. In contrast, techniques described herein utilize implicit dealiasing, which allows for dealiasing via zero-padding using two N-length buffers per input. Such techniques are associated with better empirical performance than conventional explicit zero-padding, and advantageously enable avoidance of the additional memory access operations noted above with respect to explicit zero-padding.

Embodiments of techniques described herein utilize implicit zero-padding of input data to significantly decrease memory requirements and computational complexity utilized during matrix convolution operations when compared to explicit zero-padding approaches, while nonetheless avoiding artifacts or other errors associated with circular convolution. In particular, in various embodiments each dimension of a dealiased convolution or correlation is computed using an individual (i.e., discontiguous) work buffer, eliminating the necessity for data transfers to a new buffer and allowing for the distribution of computational tasks via parallel processing. Additionally, such embodiments significantly reduce the overall memory demands associated with convolution operations, especially for multi-dimensional input data.

Thus, rather than explicitly zero-padding any input data, embodiments described herein utilize FFT operations to implicitly integrate such zero values, including in scenarios in which all input data are real (non-complex) values. For example, in certain embodiments and scenarios, real input data is treated as a complex data type for implicitly dealiased convolution, such as by splitting FFT operations in accordance with even- and odd-indexed terms, or via other arrangements in which a first subset of the real-valued input data is mapped to the real part of a complex array, while a second subset of the real-valued input data is mapped to the imaginary part of that complex array. Benefits of such techniques include a significant decrease in memory requirements for matrix convolution operations, particularly in cases involving multidimensional data, as well as an increase in computational efficiency.

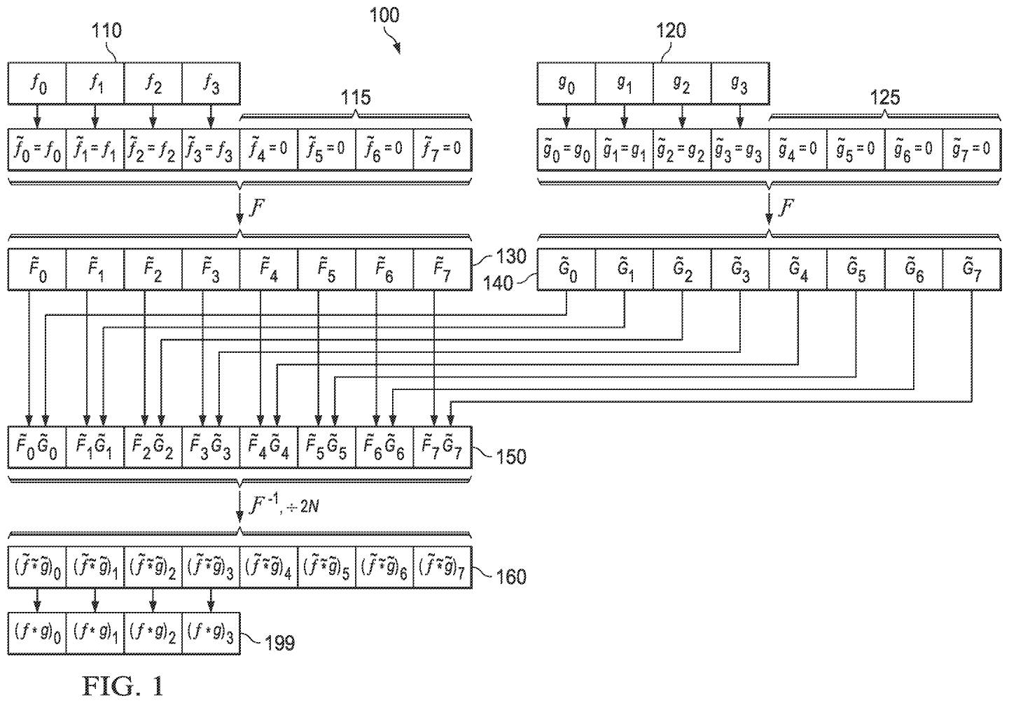

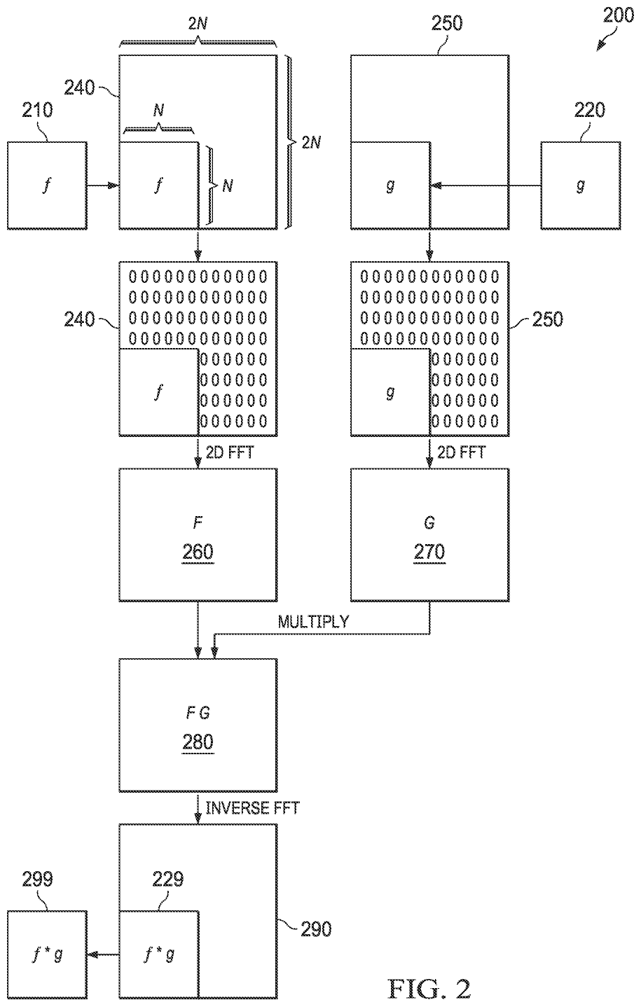

As noted above, dealiasing, as traditionally facilitated by explicit zero-padding of input data, enables the effective use of FFT for convolution operations in various dimensions by preventing unwanted aliasing and ensuring operational integrity. However, the memory requirements associated with zero-padding of multidimensional signal data are significant, as illustrated by FIG. 1 and described below.

FIG. 1 illustrates a one-dimensional (1D) matrix convolution operation 100, in which two N-length input matrices 110 (matrix f) and 120 (matrix g) are convolved, using explicit zero-padding for dealiasing, to generate a convolutional product matrix 199 (f*g). In the depicted example, a length of N=4 is selected, with the individual data elements of the input, intermediate, and output matrices being separately represented for ease of illustration. For example, input matrix 110 contains four data elements f₀, f₁, f₂, and f₃; input matrix 120 similarly contains four data elements g₀, g₁, g₂, g₃. While a length of N=4 is used here for ease of illustration, it will be appreciated that in various embodiments and scenarios, any length input matrices may be used, and that in real-world applications Nis typically much greater than 4.

In the depicted convolution operation 100, input matrices 110 and 120 are first zero-padded. In particular, input matrix 110 is padded with N 0-value padding elements 115, and input matrix 120 is similarly padded with N 0-value padding elements 125. As a result, both input matrices 110 and 120 are padded from an original N length to a convolutional source length of 2N.

Next, each of the padded input matrices are transformed via respective FFT operations, respectively resulting in the 2N-length frequency-domain intermediate matrices 130 and 140 (represented as F and G). Those two frequency-domain intermediate matrices 130 and 140 are point-multiplied to compute the pointwise (Hadamard) product matrix 150.

Finally, an inverse FFT operation is performed on the pointwise product matrix 150, resulting in the 2N-length time-domain matrix 160. Although the latter N elements of the time-domain matrix 160 are a result of the padding process and therefore are produced as a byproduct of the convolution operations, the desired result of the convolution of initial input matrices 110 and 120 is produced as only the first N elements of that time-domain matrix 160, and specifically as output matrix 199.

The additional buffer storage required for a one-dimensional convolution operation 100 is seen as the extra storage required for storing the 2N-length data for intermediate matrices 130, 140, 150, 160. However, such additional buffer storage requirements are more apparent when performing similar operations in a multi-dimensional context, as seen in FIG. 2 below.

FIG. 2 illustrates a 2D matrix convolution operation 200, in which two Nx N input matrices 210 (matrix f) and 220 (matrix g) are convolved, using explicit zero-padding for dealiasing, to generate a convolutional product matrix 299 (f*g).

In the depicted convolution operation 200, input matrices 210 and 220, both of N×N dimensions, are first respectively stored in larger input data buffers 240 and 250. As used herein, a buffer is a dedicated section of memory storage used to temporarily hold data, such as to store input data, output data, matrices, and intermediate results from one or more mathematical, transform, or other operations.

Although each of input matrices 210 and 220 include individual data elements in a manner similar to those described above with respect to input matrices 110 and 120 of the one-dimensional convolution operation 100 illustrated in FIG. 1, for ease of illustration such individual data elements are omitted from FIG. 2, as the quantity of such data elements would render the presentation of those input matrices (and the intermediate matrices utilized for convolution operation 200) unwieldy.

The input data buffers 240 and 250 are 2N×2N in dimension, effectively quadrupling the memory required to hold each of the input matrices. To prepare for the convolution process, zero values are stored in the remaining portions of the input data buffers 240 and 250 (i.e., those not occupied by the input matrices 210 and 220), illustrating the explicit zero-padding of the input data used to ensure proper transformation in the Fourier domain while retaining spatial characteristics and avoiding aliasing artifacts potentially introduced by circular convolution.

Following the zero-padding process, a two-dimensional (2D) Fast Fourier Transform (FFT) operation is applied to each of the explicitly zero-padded matrices in input data buffers 240 and 250. This transform shifts the input data from the spatial domain into the frequency domain, resulting in intermediate frequency-domain matrices F and G. These frequency-domain matrices are respectively stored within intermediate data buffers 260 and 270, both of which also have dimensions of 2N×2N.

The intermediate frequency-domain matrices F and G (the contents of intermediate buffers 260 and 270) are pointwise multiplied, producing an intermediate product matrix (F G). The intermediate product matrix represents the convolution of the original matrices in the frequency domain and is stored within yet another 2N×2N buffer, labeled as 280.

In the final stage of the matrix convolution operation 200, an inverse FFT is performed on the intermediate product matrix (F G) stored in intermediate product buffer 280 to yield the desired convolutional product matrix 299, symbolized as f*g, which is stored in results buffer 290.

As illustrated by FIG. 2, substantial buffer space is associated with the conventional approach to matrix convolution. Even in scenarios in which redundant buffering is utilized (such as by reusing input buffers 240 and 250 as intermediate buffers 260 and 270, for example), the requirement for quadrupling the original matrix dimensions through explicit zero-padding and maintaining these enlarged dimensions throughout the convolution process underscores the potential inefficiencies in terms of memory and computational resources.

In certain embodiments and scenarios, implicitly dealiasing complex convolutions is performed by splitting the FFT into even- and odd-indexed terms. Assuming that ON is the Nth root of unity, the FFT of a zero-padded input f is as follows:

$${F}_{2 n} = {\sum }_{m = 0}^{N - 1} {ω}_{2 N}^{2 nm} {f}_{n} = {\sum }_{m = 0}^{N - 1} {ω}_{N}^{nm} {f}_{n} \qquad Equation ( 2 )$$

$${F}_{2 n + 1} = {\sum }_{m = 0}^{N - 1} {ω}_{2 N}^{( 2 n + 1 ) m} {f}_{n} = {\sum }_{m = 0}^{N - 1} {ω}_{N}^{nm} {ω}_{2 N}^{m} {f}_{n} .$$

Using this split, a fully padded FFT operation may be computed using two separate buffers. A scaled inverse of the above provides:

$$\begin{matrix}{f}_{n} = {\sum }_{m = 0}^{2 N - 1} {ω}_{2 N}^{- nm} {F}_{m} \\ = {\sum }_{m = 0}^{N - 1} {ω}_{N}^{- nm} {F}_{2 m} + {ω}_{2 N}^{- n} {\sum }_{m = 0}^{N - 1} {ω}_{N}^{- nm} {F}_{2 m + 1}\end{matrix} . \qquad Equation ( 3 )$$

which allows a fully dealiased convolution on complex data using a pointwise (Hadamard) product. However, such operations do not operate successfully for scenarios in which input data is real-valued, as multiplication by roots of unity produces complex data.

In certain embodiments, implicitly dealiased convolutions are applied to real-valued data by embedding that real-valued data into the real portion of a complex array. While this would otherwise be computationally more expensive than an explicitly zero-padded convolution on real data, embodiments of techniques herein provide a high-performance implicitly padded FFT on real data in various scenarios that enables reduced buffer space and computational expense.

### Even-Length Real Input Data

For scenarios in which real-valued input data is of even length, embodiments described herein generally treat such input data as complex data of half its original length. For example, even- and odd-indexed values of the real input are mapped to the real and imaginary components of a complex representation, respectively. This effectively halves the input length for purposes of FFT operations, allowing for a more efficient computational path. Subsequent to this transformation, an FFT is performed on the restructured input.

First, define zₙ=f₂ₙ+if₂ₙ₊₁. Applying Equation (2) to {z}ₙ₌₀^{N/2-1} produces {Z₂ₙ}ₙ₌₀^{N/2-1} and {Z₂ₙ₊₁}ₙ₌₀^{N/2-1}. The result is embedding the real-valued input data in a complex array. That complex array carries the essential information of the original real-valued input, as the Fourier transform F is then recoverable via

$${F}_{0} = ( {Z}_{0} ) + ( {Z}_{0} ) \qquad Equation ( 4 )$$

$${F}_{N / 2} = ( {Z}_{0} ) - ( {Z}_{0} )$$

$${F}_{2 n} = \frac{1}{2} ( {Z}_{2 n} + {Z}_{N - 2 n}^{*} ) - {ω}_{N}^{n} \frac{i}{2} ( {Z}_{2 n} + {Z}_{N - 2 n}^{*} )$$

$${F}_{2 n + 1} = \frac{1}{2} ( {Z}_{2 n + 1} + {Z}_{N - 2 n - 1}^{*} ) - {ω}_{2 N}^{2 n + 1} \frac{i}{2} ( {Z}_{2 n + 1} + {Z}_{N - 2 n - 1}^{*} )$$

where Z* denotes the complex-conjugate of Z. Notably, the even and odd terms are managed separately, such that in various embodiments F₀, F₂, . . . , F_{N/2} are stored in one buffer holding N/2+1 complex values, and F₁, . . . , F_{N/2-1} are stored in a separate buffer containing N/2 complex values. This achieves implicit zero-padding, as well as separating the zero-padded output into two separate buffers. In certain embodiments, F₀ and F_{N/2} are consolidated into the first element, reducing storage requirements and allowing for buffer reuse.

### Inverting Equation (4) Produces

$${Z}_{2 n} = \frac{1}{2} ( {F}_{2 n} + {iF}_{N - 2 n}^{*} ) + {ω}_{N}^{n} \frac{i}{2} ( {F}_{2 n} - {iF}_{N - 2 n}^{*} ) \qquad Equation ( 5 )$$

$${Z}_{2 n + 1} = \frac{1}{2} ( {F}_{2 n + 1} + {iF}_{N - 2 n - 1}^{*} ) + {ω}_{2 N}^{2 n + 1} \frac{i}{2} ( {F}_{2 n + 1} - {iF}_{N - 2 n - 1}^{*} )$$

allowing recovery of the original input f by applying equation (3).

Thus, in various embodiments, a one-dimensional implicitly dealiased FFT-based convolution is performed as follows:
Embed the real-valued input data in the complex array

$${z}_{n} = {f}_{2 n} + {if}_{2 n + 1} ;$$

Generate intermediate results by:
   i. computing \tilde{Z}₂ₖ and \tilde{Z}₂ₖ₊₁ for all inputs;
   ii. computing \tilde{F}₂ₖ and \tilde{F}₂ₖ₊₁ for all inputs;
Perform pointwise operation(s);
Compute \tilde{Z}₂ₖ and \tilde{Z}₂ₖ₊₁ for results of the pointwise operation(s); and
Recover the convolutional product matrix by performing the inverse of the implicitly-padded complex convolution on \tilde{Z}₂ₖ and \tilde{Z}₂ₖ₊₁.

Notably, computing Zₙ=f₂ₙ+if₂ₙ₊₁ does not involve data movement. If f is contiguous, then f and z are bitwise identical, allowing the treatment of the real array as if it were simply a half-length complex array. If f is non-contiguous, then the system can advantageously store the real and imaginary parts of the complex array z in separate buffers, and perform the FFT operations accordingly.

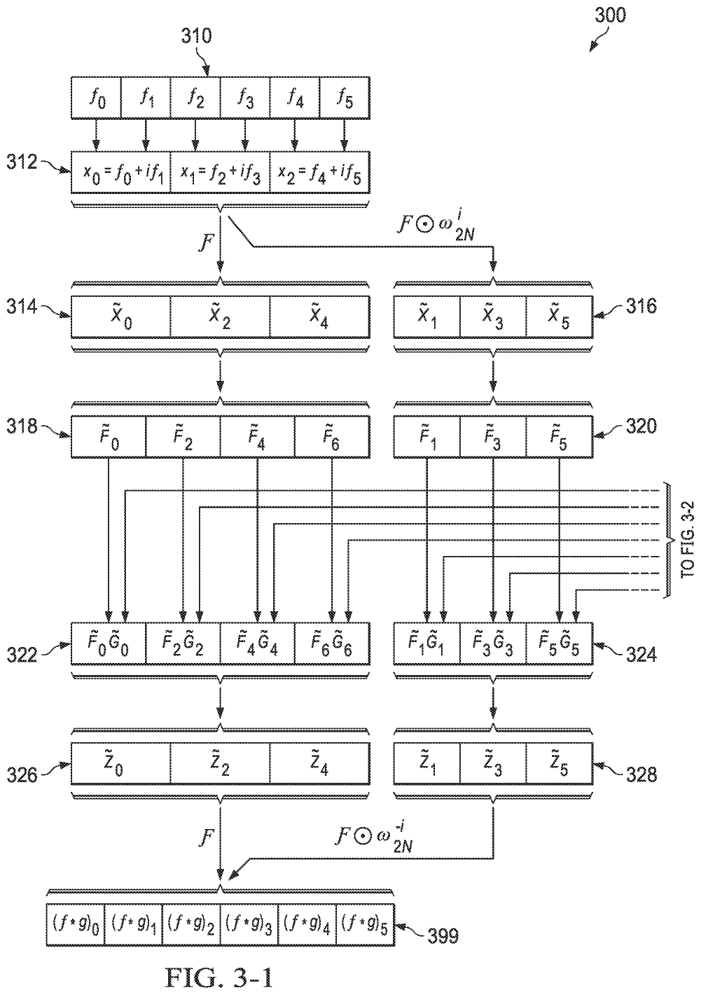

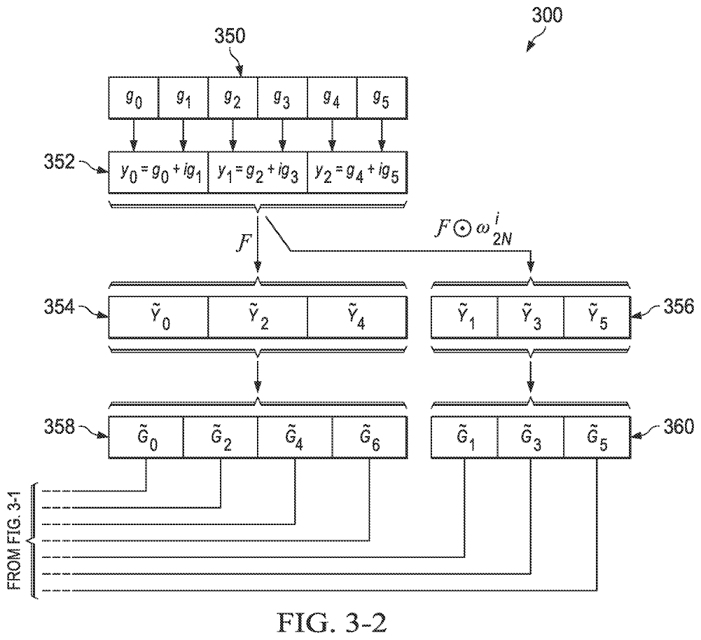

FIGS. 3-1 and 3-2 (collectively referred to herein as FIG. 3) illustrate a 1D convolution operation 300 in which two N-length input vectors 310 and 350 are convolved in accordance with some embodiments. First, the real-valued input data from each of those two input vectors is respectively embedded in complex arrays 312, 352. A Fast Fourier Transform (FFT) is performed on those complex arrays 312, 352 to produce intermediate results, which in the convolution operation 300 are the even-indexed frequency-domain vector X 314, the odd-indexed frequency-domain vector X 316, the even-indexed frequency-domain vector Y 354, and the odd-indexed frequency-domain vector Y 356. As noted above, the even-indexed and odd-indexed terms are handled separately throughout the convolution operation 300, based on the embedding of that real-valued input data in the complex arrays used as input to the FFT operations. In certain embodiments, that separate handling includes storing the even-indexed and odd-indexed terms in separate buffers.

Following the FFT of frequency-domain vectors 314, 316, 354, and 356, pointwise operations are performed on the output of frequency-domain intermediate results 318, 320, 358, 360 to provide the individual terms in complex arrays 322, 324. Those terms are used to form the final frequency-domain results 326, 328, which are then transformed to the time-domain via inverse FFT to produce the output convolution vector 399.

### Paired Convolutions for Real-Valued Input Data

In scenarios in which there are multiple inputs or outputs involved in the convolution process, embodiments again define a new complex array z, such that each element of z is a combination of corresponding elements from input matrices f and g, using one input as the real part and the other the imaginary part of the complex sequence Zₙ=fₙ+igₙ. Using that construction and applying equation (2) to the implicitly padded outputs {Z₂ₙ}ₙ₌₀^{N-1} and {Z₂ₙ₊₁}ₙ₌₀^{N-1}, embodiments can recover F and G via

$${F}_{0} = ( {Z}_{0} ) , {G}_{0} = ( {Z}_{0} ) \qquad Equation ( 6 )$$

$${F}_{2 n} = \frac{{Z}_{2 n} + {Z}_{2 N - 2 n}^{*}}{2} , {G}_{2 n} = \frac{{Z}_{2 n} - {Z}_{2 N - 2 n}^{*}}{2 i}$$

$${F}_{2 n + 1} = \frac{{Z}_{2 N + 2 n + 1} + {Z}_{2 N - 2 n - 1}^{*}}{2}$$

$${G}_{2 n + 1} = \frac{{Z}_{2 N + 2 n + 1} + {Z}_{2 N - 2 n - 1}^{*}}{2 i} .$$

This is inverted via

$${Z}_{0} = {F}_{0} + {iG}_{0} , \qquad Equation ( 7 )$$

$${Z}_{2 n} = {F}_{2 n} + {iG}_{2 n} ,$$

$${Z}_{2 N - 2 n} = {F}_{2 n}^{*} + {iG}_{2 n}^{*}$$

$${Z}_{2 n + 1} = {F}_{2 n + 1} + {iG}_{2 n + 1}$$

$${Z}_{2 N - 2 n - 1} = {F}_{2 n + 1}^{*} + {iG}_{2 n + 1}^{*}$$

Using these, the system may utilize the approach described above for generating the output convolution matrix vector 399 in a manner similar to that used for even-length inputs.

### Multidimensional Operations

The convolution process described elsewhere herein for single-dimension input may be used as the basis for efficient convolution operations using multi-dimensional real-valued input as well. Once again, the real-valued input data is embedded in a complex array, preparing it for the FFT-based convolution process. This extension to multiple dimensions broadens the applicability of techniques described herein to a wider range of real-world scenarios in which multi-dimensional data is common.

For multi-dimensional data, FFTs are applied by initially performing a real-to-complex transform in one dimension, typically one in which the data is contiguous, with subsequent complex-to-complex transforms in the remaining dimensions. If the length of this contiguous dimension is even, the even-length implicitly-padded real-to-complex FFT algorithm described above is employed.

However, if the contiguous dimension does not have an even length, but another dimension does, the system may first execute a real-to-complex transform in that even-length dimension. This approach may alter the symmetrization of the output, but it doesn't affect the convolution's end goal, and pointwise multiplication of the frequency-domain intermediate results can still be performed.

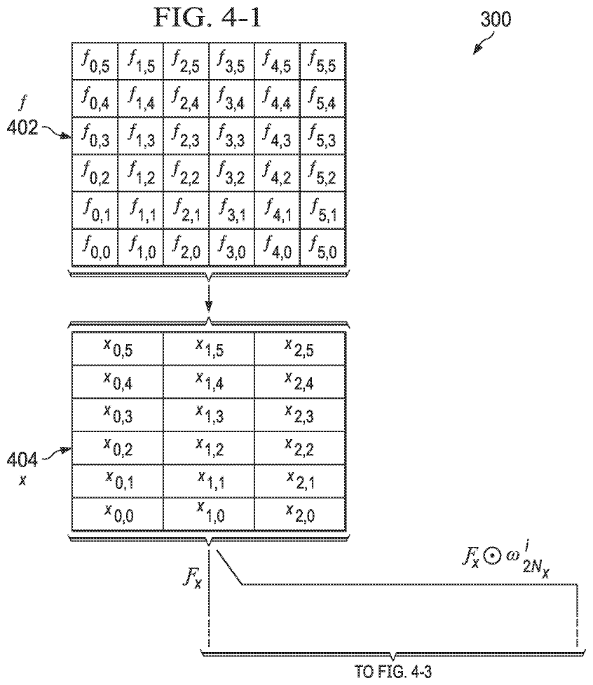

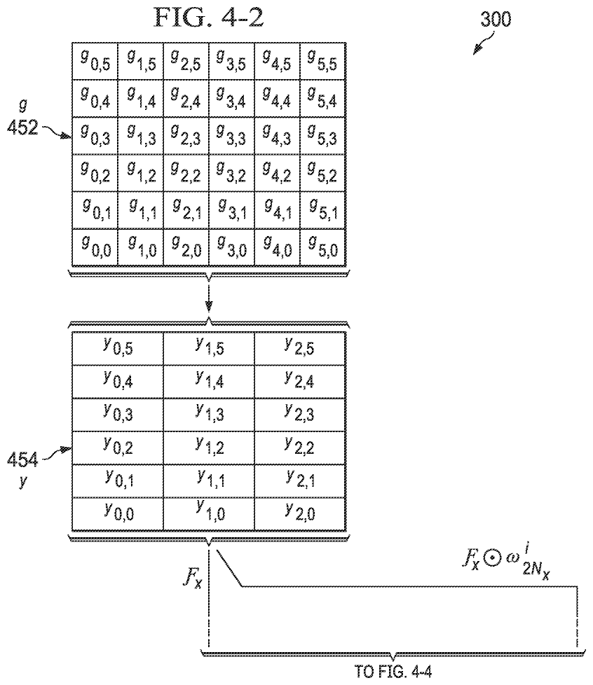

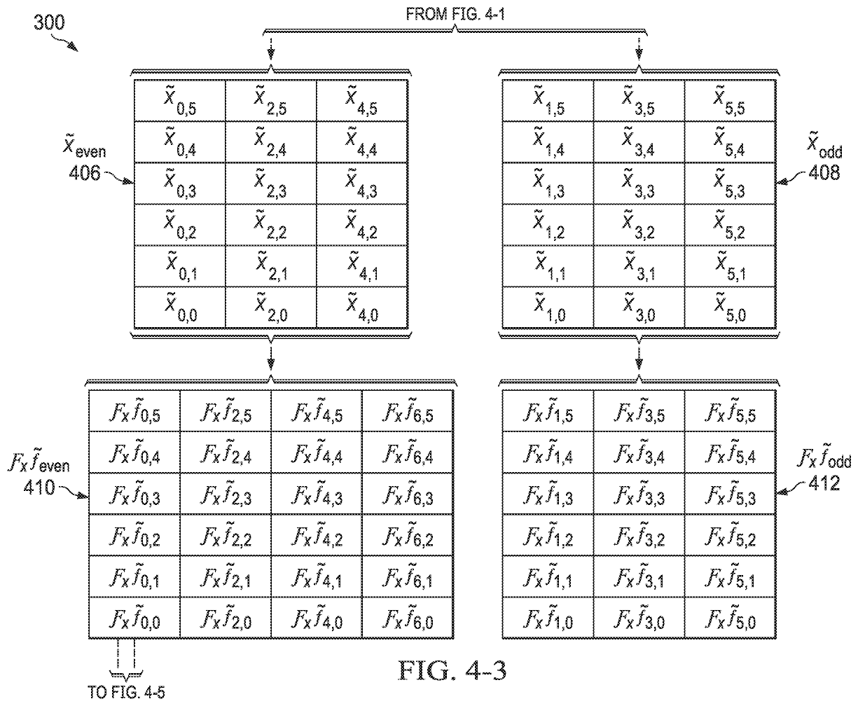

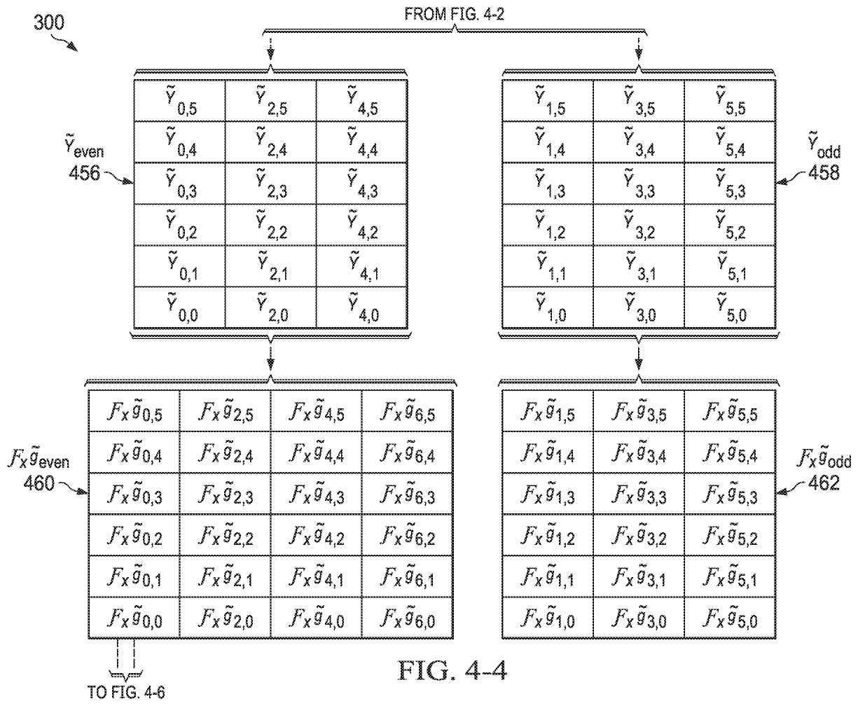

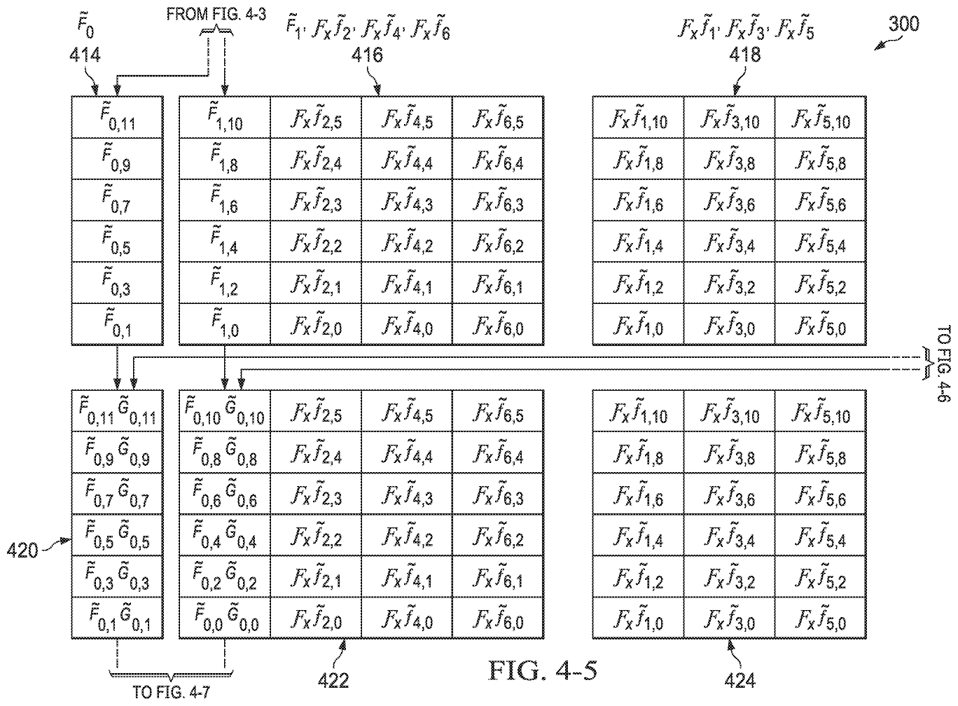

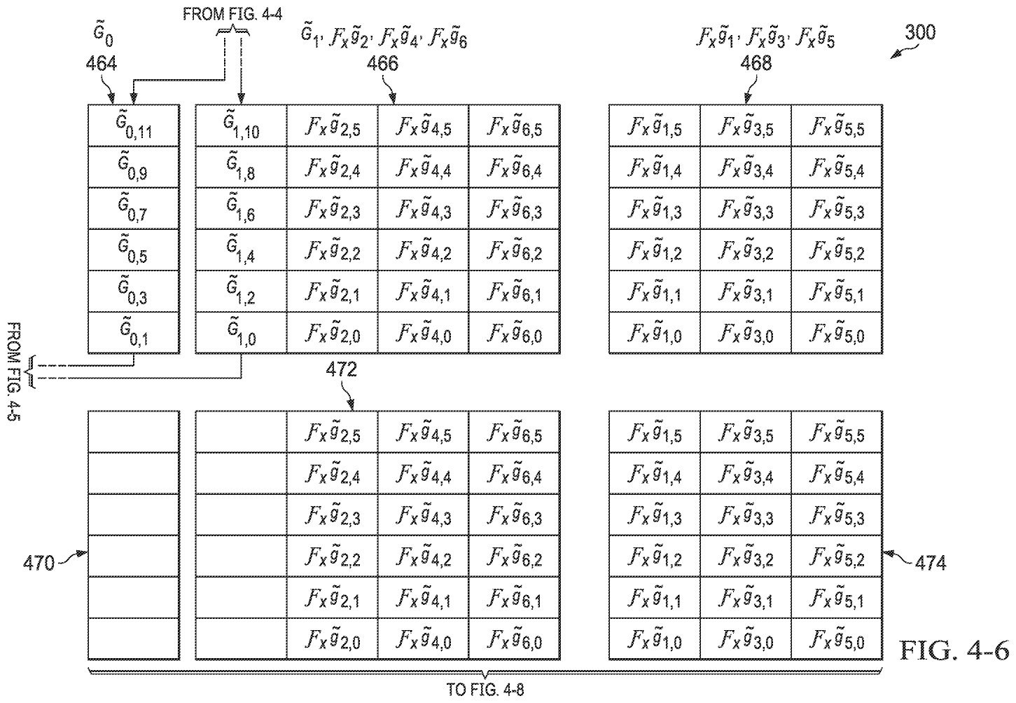

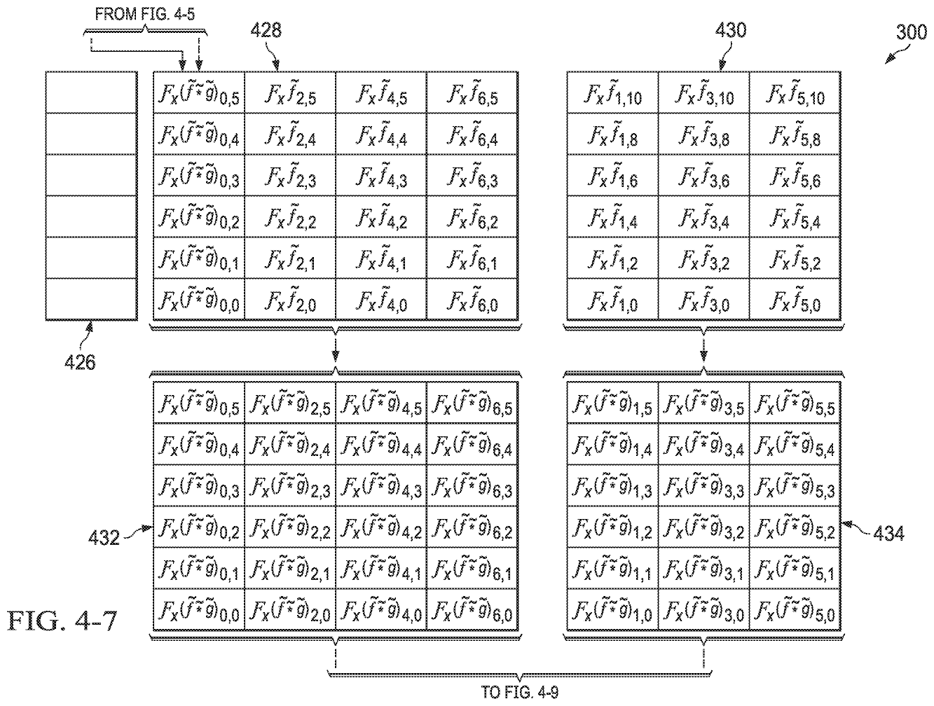

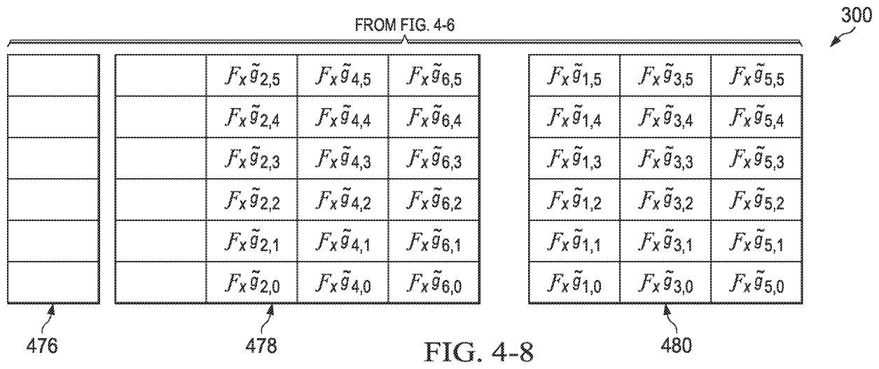

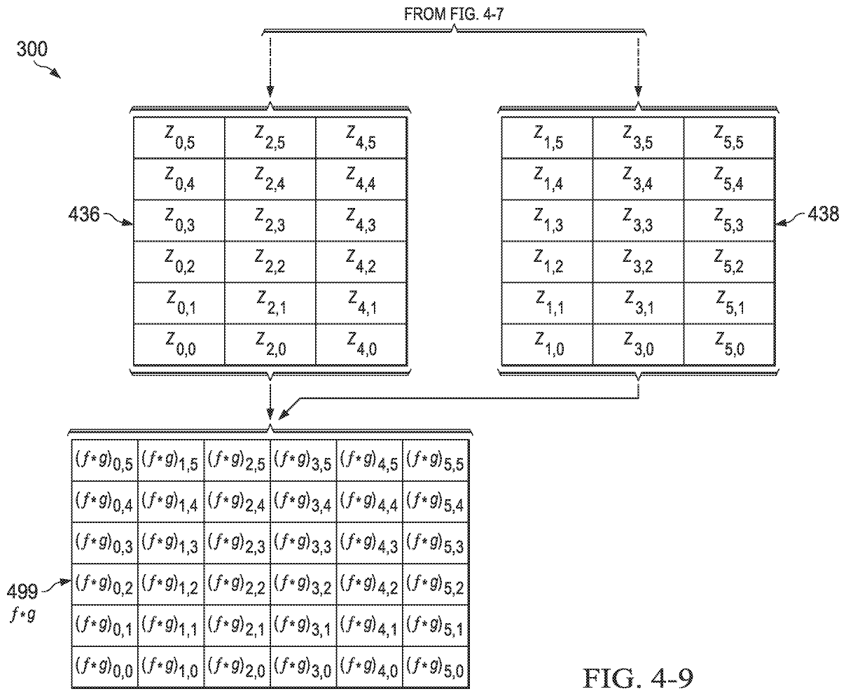

FIGS. 4-1 to 4-9 (collectively referred to herein as FIG. 4) illustrate a 2D matrix convolution operation 400 in which two N×N input matrices 402 (f) and 452 (g) are convolved in accordance with some embodiments. The input matrices 402, 452 are first embedded in respective complex arrays 404, 454, which are then transformed via FFT operations with respect to the x-dimension into their frequency-domain representations: the columns of the resulting complex matrix X (the frequency-domain representation of complex array 404) are split into even- and odd-indexed columns to produce frequency-domain component matrices 406, 408; the columns of the resulting complex matrix Y (the frequency-domain representation of complex array 454) are similarly split into even- and odd-indexed columns to produce frequency-domain component matrices 456, 458.

Each of the frequency-domain component matrices 406, 408, 456, 458 are transformed again via FFT operations to produce the frequency-domain complex arrays 410, 412, 460, 462, which are then rearranged to form frequency-domain component matrices 414, 416, 418 and 464, 466, 468. Information from the frequency-domain component matrices 464 and 466, corresponding to the Go and Gi columns of those component matrices 464 and 466, are then used as inputs to pointwise multiplication operations in order to supplement columns of the frequency-domain component matrices 414 and 416 to produce terms of the intermediate frequency-domain matrices 420, 422, 424. Inverse FFT operations are then performed on the resulting component complex matrices 428 and 430 to produce additional frequency-domain component matrices 432, 434. It will be appreciated that other than those Go and Gi columns of the component matrices 464 and 466, the information of matrices 466, 468, 472, 474, 478, and 480 are discarded as corresponding to the falsely complex components of the original complex array 454.

As described above with respect to Equations (5), (6) and (7), the even- and odd-indexed columns of frequency-domain output matrices produce Z as the frequency-domain output matrices 436, 438, which are then used as inputs to inverse FFT operations to produce the output convolution matrix 499.

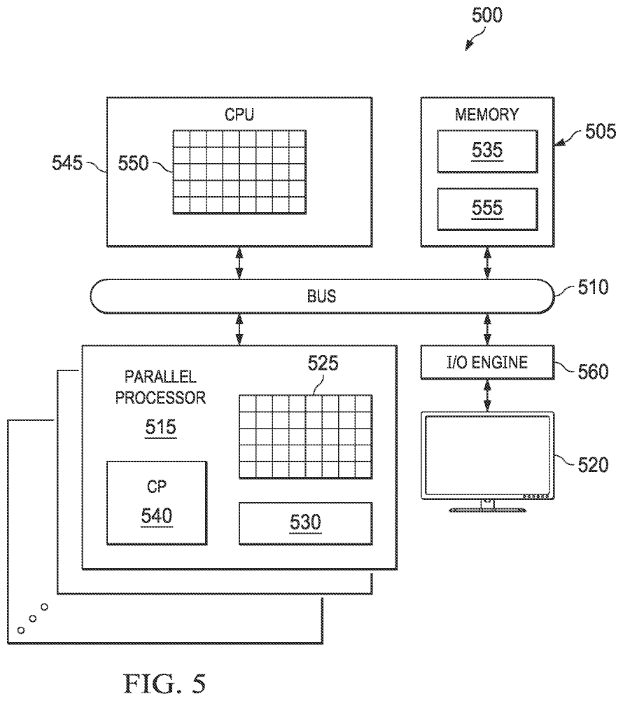

FIG. 5 is a block diagram of a processing system 500 designed to perform convolution operations in accordance with one or more embodiments and techniques described herein. The processing system 500 is generally designed to execute sets of instructions or commands to carry out tasks on behalf of an electronic device, such as a desktop computer, laptop computer, server, smartphone, tablet, game console, and the like.

The processing system 500 includes or has access to a memory 505 or other storage component that is implemented using a non-transitory computer readable medium, such as dynamic random access memory (DRAM). The processing system 500 also includes a bus 510 to support communication between entities implemented in the processing system 500, such as the memory 505. In certain embodiments, the processing system 500 includes other buses, bridges, switches, routers, and the like, which are not shown in FIG. 5 in the interest of clarity.

The processing system 500 includes one or more parallel processors 515 that are configured to generate content for presentation on a display 520. A parallel processor is a processor that is able to execute a single instruction on multiple data or threads in a parallel manner. Examples of parallel processors include graphics processing units (GPUs), massively parallel processors, single instruction multiple data (SIMD) architecture processors, and single instruction multiple thread (SIMT) architecture processors for performing graphics, machine intelligence, or compute operations. The parallel processor 515 can render objects to produce pixel values that are provided to the display 520. In some implementations, parallel processors are separate devices that are included as part of a computer. In other implementations such as advance processor units, parallel processors are included in a single device along with a host processor such as a central processor unit (CPU). Thus, although embodiments described herein may utilize a GPU for illustration purposes, various embodiments and implementations are applicable to other types of parallel processors.

In certain embodiments, the parallel processor 515 is also used for general-purpose computing. For instance, the parallel processor 515 can be used to implement matrix multiplication operations, such as one or more implementations of matrix multiplication and/or convolution operations as described herein. In various scenarios and embodiments, operations of multiple parallel processors 515 are coordinated to execute various processing tasks.

The parallel processor 515 implements multiple processing elements (also referred to as compute units) 525 that are configured to execute instructions concurrently or in parallel. The parallel processor 515 also includes an internal (or on-chip) memory 530 that includes a local data store (LDS), as well as caches, registers, or buffers utilized by the compute units 525. The parallel processor 515 can execute instructions stored in the memory 505 and store information in the memory 505 such as the results of the executed instructions. The parallel processor 515 also includes a command processor 540 that receives task requests and dispatches tasks to one or more of the compute units 525.

The processing system 500 also includes a central processing unit (CPU) 545 that is connected to the bus 510 and communicates with the parallel processor 515 and the memory 505 via the bus 510. The CPU 545 implements multiple processing elements (also referred to as processor cores) 550 that are configured to execute instructions concurrently or in parallel. The CPU 545 can execute instructions such as program code 555 stored in the memory 505 and the CPU 545 can store information in the memory 505 such as the results of the executed instructions.

An input/output (I/O) engine 560 comprises interface circuitry that, in combination with the CPU 545, handles input or output operations associated with the display 520, as well as other elements of the processing system 500 such as keyboards, mice, printers, external disks, and the like. The I/O engine 560 is coupled to the bus 510 so that the I/O engine 560 communicates with the memory 505, the parallel processor 515, or the CPU 545.

In operation, the CPU 545 issues commands to the parallel processor 515 to initiate processing of a kernel that represents the program instructions that are executed by the parallel processor 515. Multiple instances of the kernel, referred to herein as threads or work items, are executed concurrently or in parallel using subsets of the compute units 525. In some embodiments, the threads execute according to single-instruction-multiple-data (SIMD) protocols so that each thread executes the same instruction on different data. The threads are collected into workgroups (also termed thread groups) that are executed on different compute units 525. For example, the command processor 540 can receive these commands and schedule tasks for execution on the compute units 525.

In various embodiments, each computational and/or communications task performed as part of convolution operations is processed in parallel by the compute units 525 in the parallel processor 515. As discussed elsewhere herein, this approach enables efficient convolution operations without excessive buffer storage or processing overhead in a wide range of devices and applications.

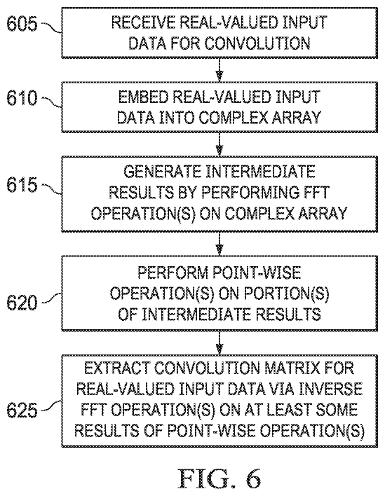

FIG. 6 is a flow diagram illustrating an operational routine 600 for performing convolution operations in accordance with one or more embodiments. The operational routine 600 may be performed, for example, by the processing system 500 of FIG. 5 or other processing system.

The operational routine 600 begins at block 605, in which the processing system receives real-valued input data designated for convolution. Such real-valued input data may, for example, comprise data similar to that described elsewhere herein with respect to input vectors 310 and 350 of FIG. 3 or input matrices 402 and 452 of FIG. 4, and be received via a memory or I/O engine of the processing system (e.g., memory 505 or I/O engine 560 of FIG. 5). The routine proceeds to block 610.

At block 610, the received real-valued input data is embedded into a complex array (e.g., as described above with respect to complex arrays 312 and 352 of FIG. 3, or complex arrays 404 and 454 of FIG. 4). This embedding involves a transformation process in which real data elements are mapped into a complex data structure, preparing the data for efficient Fast Fourier Transform (FFT) processing. In various embodiments, as described in greater detail elsewhere herein, this preparation includes mapping first and second subsets of the real-valued input data (e.g., even-indexed and odd-indexed elements, respectively) into real and imaginary parts of the complex array. The routine proceeds to block 615.

At block 615, the processing system proceeds to generate intermediate results by performing one or more FFT operations on the complex array. These operations transform the data of the complex array into the frequency domain (e.g., as described above with respect to frequency-domain vectors 314, 316, 354, 356 of FIG. 3 and frequency-domain component matrices 406, 408, 456, 458 of FIG. 4). The routine proceeds to block 620.

At block 620, the processing system performs one or more pointwise operations on portions of the intermediate results. In certain embodiments, such pointwise operations include the multiplication of corresponding frequency components of the transformed data sets (such as described above with respect to the generation of the individual terms of complex arrays 322, 324 of FIG. 3 and those of intermediate frequency-domain matrices 420, 422, 424 of FIG. 4). The routine proceeds to block 625.

At block 625, the processing system extracts the convolution matrix for the real-valued input data. This extraction is accomplished via one or more inverse FFT operations on at least some of the results of the pointwise operations conducted in the previous step (e.g., on frequency-domain results 326, 328 of FIG. 3, or on frequency-domain output matrices 436, 438 of FIG. 4). The inverse FFT transforms the convolved data back into the time or spatial domain, yielding the convolved output (e.g., output convolution vector 399 of FIG. 3 or output convolution matrix 499 of FIG. 4) for the real-valued input data received in block 605.

In some embodiments, the apparatus and techniques described above are implemented in a system including one or more integrated circuit (IC) devices (also referred to as integrated circuit packages or microchips), such as the convolution and other operations described above with reference to FIGS. 3-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving real-valued input data for convolution;
embedding the real-valued input data into a complex array;
generating intermediate results by performing one or more fast Fourier transform (FFT) operations on the complex array;
performing one or more pointwise operations on one or more portions of the intermediate results;
extracting a convolution matrix for the real-valued input data via one or more inverse FFT operations on at least some results of the one or more pointwise operations; and
providing the extracted convolution matrix as output of the convolution.

2. The method of claim 1, wherein embedding the real-valued input data into the complex array comprises mapping a first subset of the real-valued input data to real parts of the complex array and mapping a second subset of the real-valued input data to imaginary parts of the complex array.

3. The method of claim 2, wherein embedding the real-valued input data into the complex array further comprises storing the first subset of the real-valued input data in a first buffer and storing the second subset of the real-valued input data in a second buffer.

4. The method of claim 2, wherein the first subset comprises even-indexed terms of the real-valued input data and wherein the second subset comprises odd-indexed terms of the real-valued input data.

5. The method of claim 2, wherein the first subset comprises a first set of real-valued data to be convolved with a second set of real-valued data, and wherein the second subset comprises the second set of real-valued data.

6. The method of claim 1, wherein the real-valued input data comprises a dimensionality of two or more dimensions, and wherein the one or more FFT operations are performed with respect to the dimensionality of the real-valued input data.

7. The method of claim 1, wherein the real-valued input data comprises a first set of real-valued data and a second set of real-valued data, and wherein embedding the real-valued input data into the complex array comprises combining elements from the first set and from the second set into single complex elements.

8. A system, comprising:
a plurality of buffers; and
one or more processors communicatively coupled to the plurality of buffers, the one or more processors configured to:
receive real-valued input data for convolution;
embed the real-valued input data into a complex array;
generate intermediate results by performing one or more fast Fourier transform (FFT) operations on the complex array;
perform one or more pointwise operations on one or more portions of the intermediate results;
extract a convolution matrix for the real-valued input data via one or more inverse FFT operations on at least some results of the one or more pointwise operations; and
provide the extracted convolution matrix as output of the convolution.

9. The system of claim 8, wherein to embed the real-valued input data into the complex array comprises to map a first subset of the real-valued input data to real parts of the complex array and to map a second subset of the real-valued input data to imaginary parts of the complex array.

10. The system of claim 9, wherein the one or more processors are further to store the first subset of the real-valued input data in a first buffer of the plurality of buffers and to store the second subset of the real-valued input data in a second buffer of the plurality of buffers.

11. The system of claim 9, wherein the first subset comprises even-indexed terms of the real-valued input data and wherein the second subset comprises odd-indexed terms of the real-valued input data.

12. The system of claim 9, wherein the first subset comprises a first set of real-valued data to be convolved with a second set of real-valued data, and wherein the second subset comprises the second set of real-valued data.

13. The system of claim 8, wherein the real-valued input data comprises a dimensionality of two or more dimensions, and wherein the one or more FFT operations are performed with respect to the dimensionality of the real-valued input data.

14. The system of claim 8, wherein the real-valued input data comprises a first set of real-valued data and a second set of real-valued data, and wherein to embed the real-valued input data into the complex array includes to combine elements from the first set and from the second set into single complex elements.

15. A non-transitory computer-readable medium storing a set of executable instructions, the set of executable instructions to manipulate at least one processor to:
receive real-valued input data for convolution;
embed the real-valued input data into a complex array;
generate intermediate results by performing one or more fast Fourier transform (FFT) operations on the complex array;
perform one or more pointwise operations on one or more portions of the intermediate results;
extract a convolution matrix for the real-valued input data via one or more inverse FFT operations on at least some results of the one or more pointwise operations; and
provide the extracted convolution matrix as output of the convolution.

16. The non-transitory computer-readable medium of claim 15, wherein to embed the real-valued input data into the complex array comprises to map a first subset of the real-valued input data to real parts of the complex array and to map a second subset of the real-valued input data to imaginary parts of the complex array.

17. The non-transitory computer-readable medium of claim 16, wherein the set of executable instructions further manipulate the at least one processor to store the first subset of the real-valued input data in a first buffer and to store the second subset of the real-valued input data in a second buffer.

18. The non-transitory computer-readable medium of claim 16, wherein the first subset comprises even-indexed terms of the real-valued input data and wherein the second subset comprises odd-indexed terms of the real-valued input data.

19. The non-transitory computer-readable medium of claim 16, wherein the first subset comprises a first set of real-valued data to be convolved with a second set of real-valued data, and wherein the second subset comprises the second set of real-valued data.

20. The non-transitory computer-readable medium of claim 15, wherein the real-valued input data comprises a dimensionality of two or more dimensions, and wherein the one or more FFT operations are performed with respect to the dimensionality of the real-valued input data.
